(19) United States
(12) Patent Application Publication
(10) Pub. No.: US 2006/0210763 A1
(43) Pub. Date: Sep. 21, 2006

(54) WRAP FOR LUGGAGE HANDLE AND THE LIKE

(76) Inventor: Adam Matthew Holms, Goleta, CA (US)

Correspondence Address: LAURA N. TUNNELL, P.O. BOX 91929, SANTA BARBARA, CA, 93190, US

(21) Appl. No.: 10/907,021

(22) Filed: Mar. 16, 2005

(51) Int. Cl. B32B 3/06

(52) U.S. Cl. 428/100

(57) ABSTRACT

An adjustable wrapping device comprising a flexible sheet of a compressible elastomer affixed to a sheet of a reinforcing fabric to form a laminated sheet. The sheet of compressible elastomer has an upper and lower surface wherein at least one of the surfaces is textured. A colored fabric is preferably affixed to at least one peripheral edge of the laminated sheet. The adjustable wrapping device further includes means for releasably attaching an upper half portion of the laminated sheet to a lower opposing half portion of the laminated sheet to enable the device to be formed into a cylindrical structure of varying diameter. The device is operable for wrapping around the handle of luggage to provide a distinguishing color and ease of handling for luggage and the like.

The present invention relates to a wrapping device and, more particularly, to a device that can be wrapped around a portion of an article, such as a luggage handle.

Holms, in a copending U.S. patent application Ser. No. 10/780,361 discloses a wrap for conditioning the interface between a part of an article and a user's body as well as a method for making and using the wrap. The wrap provides a flexible, resiliently compressible, elastic pad that is shaped into a tubular configuration for wrapping around part of an article, such as a luggage handle. The inside surface of an end segment disposed at one end of the pad overlaps and releaseably attaches to the outside surface of an end segment at the opposing end of the pad. In addition, at least one side of the pad has a non-slip surface so that it does not rotate freely around the wrapped portion of the article nor does it slip from one's grip. Details for making the wrap are presented in the aforesaid U.S. patent application Ser. No. 10/780,361, and are herein incorporated by reference.

The above-referenced prior art device, while suitable for providing a secure grip in many applications, has some disadvantages. When the device is in a wrapped configuration, the device essentially forms a soft tubular barrier between the article being wrapped, usually a handle affixed to an article of luggage, and a person's hand. The tubular configuration is maintained by “hook and loop” or similar type attachment strips affixed to the edge of opposing ends. The diameter of the tube is predetermined by the width of these attachment strips, and has a limited range. Moreover, the person using the wrapping device must tolerate the discomfort of additional bulk due to the attachment strips disposed to underlie the hand when the device is gripped. It is, therefore, desirable to provide a wrap similar to the wrap disclosed in Holms Ser. No. 10/780,361 but having a more comfortable attachment means and a wider range of cylindrical diameter.

### SUMMARY

It is an object of the present invention to provide an adjustable wrap operable for wrapping around a portion of an article, thereafter the wrap presenting a non-slip article-contacting surface.

It is a further object of the present invention to provide an adjustable wrap operable for wrapping around a portion of an article, thereafter the wrap presenting a non-slip outer gripping surface.

It is a further object of the invention to provide an adjustable wrapping device meeting the above objectives and including means for visually identifying a particular article bearing an adjustable wrapping device among a plurality of similar articles.

It is a further object of the invention to provide an adjustable wrapping device devoid of extraneous bulkiness that is uncomfortable to the user.

It is yet a further object of the invention to provide an adjustable wrapping device meeting the above objectives and including means for variably adjusting the diameter in order to accommodate articles having widely ranging circumferences.

The above objectives are met by the provision of an adjustable wrapping device comprising a flexible sheet of a compressible elastomer adhered to a sheet of a reinforcing fabric to form a laminated sheet. The sheet of compressible elastomer has an upper and lower surface wherein at least one of the surfaces is textured. The layer of reinforcing fabric may be interposed between an upper surface and an opposing surface of the sheet of compressible elastomer or adhered directly to the upper or lower surface of the sheet of compressible elastomer. The peripheral edges of the reinforcing fabric preferably extend beyond the peripheral edges of the sheet of compressible elastomer and are folded over the sheet such that the fabric is visible from at least one edge of the wrapping device. The visible portion of the reinforcing fabric preferably bears a distinctive color such that it may be visually recognized from a distance. Alternatively, a colored fabric may be affixed to at least one peripheral edge of the laminated sheet. The adjustable wrapping device further includes means for releasably attaching an upper half portion of the laminated sheet to a lower opposing half portion of the laminated sheet to enable the device to be formed into a cylindrical structure of varying diameter.

The features of the invention believed to be novel are set forth with particularity in the appended claims. However the invention itself, both as to organization and method of operation, together with further objects and advantages thereof may be best understood by reference to the following description taken in conjunction with the accompanying drawings.

### DESCRIPTION OF THE PREFERRED EMBODIMENTS

The definitions below serve to provide a clear and consistent understanding of the specification and claims, including the scope given to such terms.

The term “hook and loop closure”, as used herein, means a closure consisting of a fabric section having a plurality of small loops thereon, herein referred to as “small loops”, that releasably engage a corresponding fabric having a plurality of small hooks thereon, herein referred to as “small hooks” such as is found in the fabric manufactured under the name “velcro”. It should be articulated that, among the many “hook and loop” closures described herein, it is only necessary to have one closure surface covered with one member of the “hook and loop” pair, while the opposing surface is covered with the opposing member. For example, a configuration in which the first surface is covered with hooks and the second surface is covered with loops, is entirely equivalent to the complementary configuration in which the first surface is covered with loops and the second surface is covered with hooks, given that each respective surface only interacts with the opposing surface.

### BRIEF DESCRIPTION OF THE DRAWINGS

FIG. 1—Wrap deployed in its functional configuration.

FIG. 2—Inside surface of a prior art wrap showing hook and loop closure strips.

FIG. 3—Outside surface of a prior art wrap showing hook and loop closure strips.

FIG. 4—End on view of prior art wrap detailing maximal and minimal overlap of hook and loop closure strips.

FIG. 5—Inside surface of present wrap showing hook and loop closure strips.

FIG. 6—Outside surface of present wrap showing hook and loop closure strips.

FIG. 7—End on view of wrap of present invention detailing maximal and minimal overlap of hook and loop closure strips.

FIG. 8—Inside view of alternate embodiment of present invention.

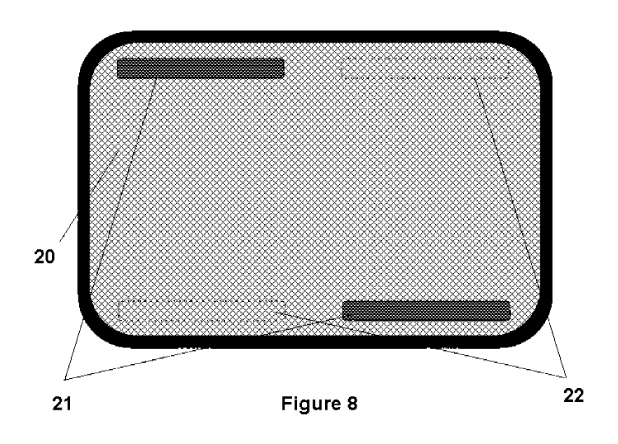

FIG. 9—Outside view of alternate embodiment of present invention.

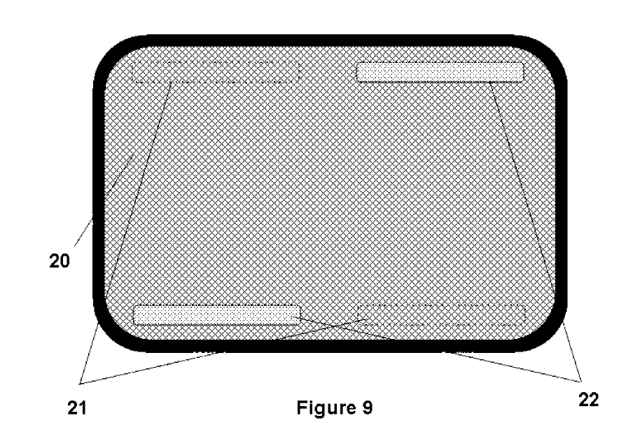

FIG. 10—Inside view of second alternate embodiment of present invention.

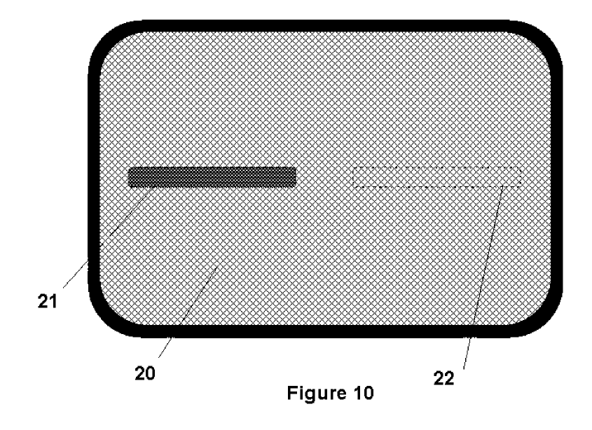

FIG. 11—Outside view of second alternate embodiment of present invention.

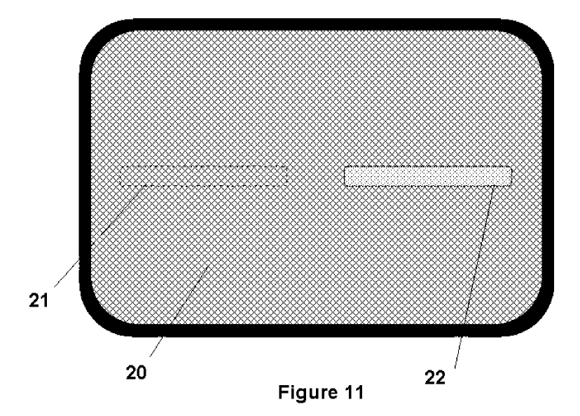

### IDENTIFICATION OF NUMBERS USED IN THE DRAWINGS

10—wrap

20—inside surface of wrap

21—first component of hook and loop closure

22—second component of hook and loop closure

23—radial edge of the wrap

24—axial edge of the wrap

40—prior art overlap region of hook and loop closure strips

41—minimum overlap of prior art hook and loop closure strips

42—maximum overlap of prior art hook and loop closure strips

70—overlap region of hook and loop closure strips of present invention

71—minimum overlap of hook and loop closure strips

72—maximum overlap of hook and loop closure strips

### DETAILED DESCRIPTION OF THE PREFERRED EMBODIMENTS

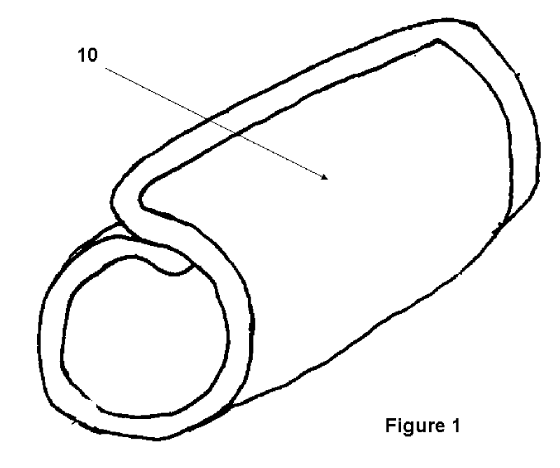

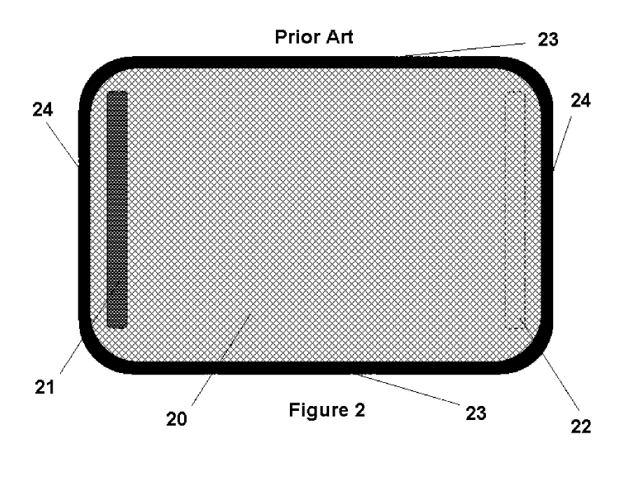

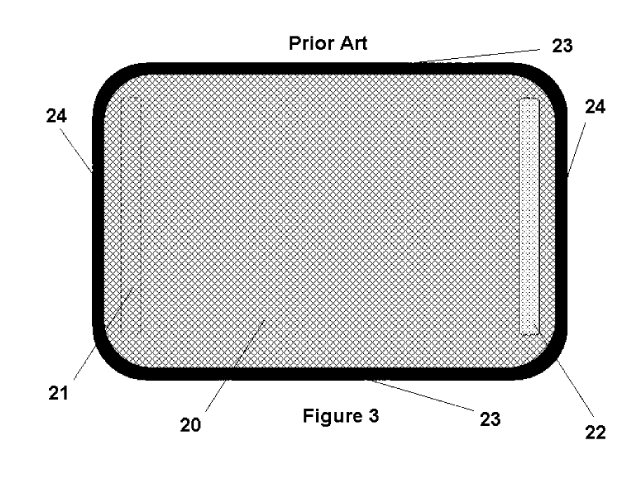

The wrap (10), indicated in a functional configuration in FIG. 1, is shown unfurled in FIGS. 2, 4, 6 and 7. For comparison, the various components of the prior art wrap are shown in FIGS. 2 and 3. FIG. 2 illustrates the inside surface (20) of the unfurled prior art wrap, as well as the complementary hook and loop components, (21) and (22). In FIG. 3, the rolled prior art wrap is shown edge on, with detail of the overlap region (40) of the hook and loop components. Note that the degree of overlap, and consequently the diameter of the cylindrical roll, is determined by the width of the hook and loop closure strips (21), (22). A minimal degree of overlap is indicated at (41), and a maximal degree at (42). The variation in diameter range for the two configurations is only about one sixth the width of the hook and loop closure strips, (21) or (22). In addition to this limitation, the strips are placed along the axial dimension (24). When the wrap is rolled, this results in an extraneous line of bulk, interfering with the user's grip and creating an unnecessary and uncomfortable pressure.

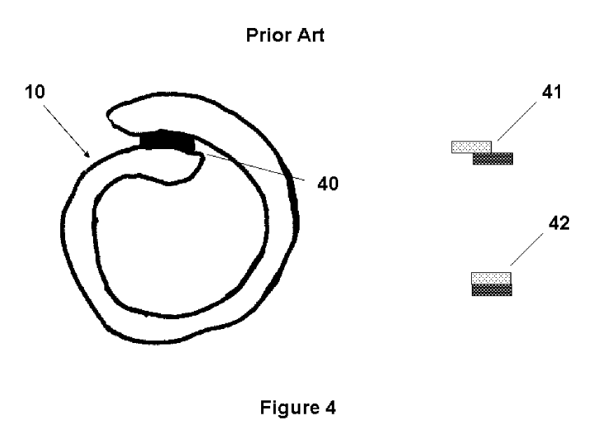

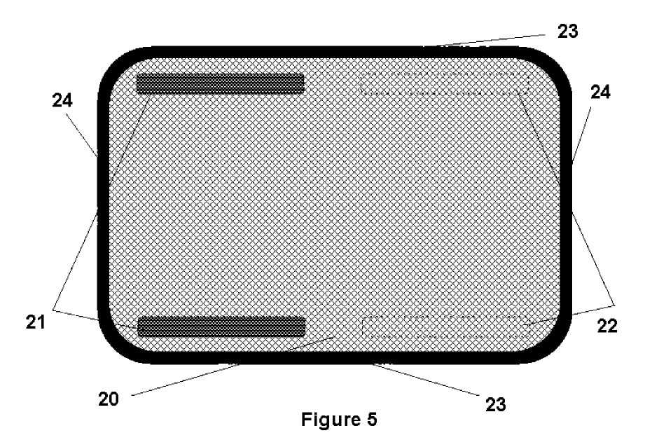

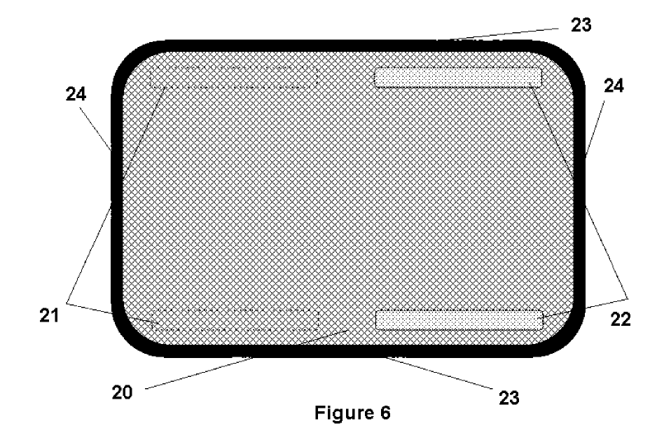

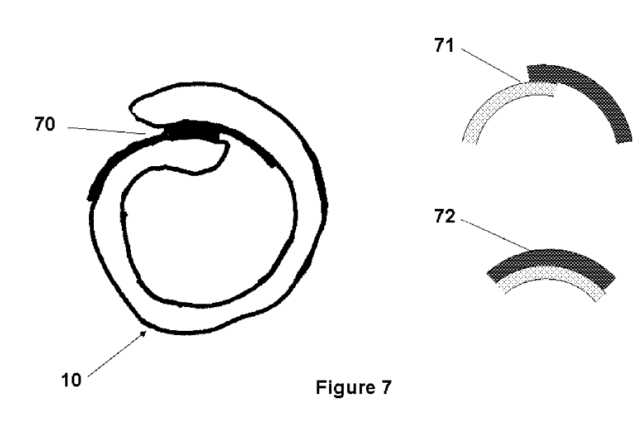

A significant modification to the prior art wrap is delineated in FIGS. 4-7. Many of the above limitations are relieved by aligning the long dimension of the hook and loop closure strips (21) and (22) with the radial edge (23) of the wrap (20). The advantage to this modification can be seen in FIG. 5. The overlap region (70) of the strips now has a range of approximately zero to twice the length of the hook and loop closure strips (21) and (22). The minimal overlap is indicated at (71), the maximal overlap at (72). In addition to an extended range of variable diameters, the hook and loop closure strips (21) and (22) are aligned in such a way that they can easily be avoided by the fingers, and thereby not cause discomfort due to their extraneous bulk. Additional embodiments of this basic idea are shown in FIGS. 6-7. These figures, as well as FIG. 4, are constrained by the requirement that the strip placement is mirrored along a line parallel to the radial dimension (23) and bisecting the axial dimension (24) of the wrap (20). Any configuration satisfying this basic requirement will have the advantages characterizing the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1-2. (canceled)

3. An adjustable device operable for wrapping around the handle of a piece of luggage comprising:
a. a flexible, rectangular, laminated sheet, wherein said flexible sheet is comprised of a compressible closed-cell foam elastomer having a textured, non-slip surface and a smooth opposing surface, said smooth opposing surface being laminated to a sheet of substantially non-extending reinforcing fabric,
b. wherein said flexible sheet is operable for being rolled into a cylindrical configuration to envelope said handle, said cylindrical configuration having a length, a radius, a radial edge and an axial edge,
c. at least one hook and loop closure strip having a long dimension and a short dimension, said long dimension being parallel to said radial edge enabling said radius to be adjustable upon being rolled into said cylindrical configuration, and enabling said hook and loop closure strip to be easily interspersed with the fingers when said fingers grasp said handle.
